(19) United States
(12) Patent Application Publication
(10) Pub. No.: US 2026/0367470 A1
(43) Pub. Date: Nov. 19, 2026

(54) TRANSVERSE-MODE-ENCODED QUANTUM PROCESSOR

(71) Applicant: THE ROYAL INSTITUTION FOR THE ADVANCEMENT OF LEARNING / MCGILL UNIVERSITY, Montreal (CA)

(72) Inventors: Hassan RAHBARDAR MOJAVER, La Prairie (CA); Odile LIBOIRON-LADOUCEUR, Montreal (CA); Seyed Mohammad Reza SAFAEE ARDESTANI, Verdun (CA)

(21) Appl. No.: 19/488,920

(22) PCT Filed: Jun. 3, 2024
(86) PCT No.: PCT/CA2024/050741

§ 371 Date: Dec. 1, 2025

Related U.S. Application Data
(60) Provisional application No. 63/470,617, filed on Jun. 2, 2023.

(51) Int. Cl. G02F 1/225; G06N 10/40

(52) U.S. Cl. CPC G02F 1/225; G06N 10/40; G02F 2203/50

(57) ABSTRACT

A quantum processing unit comprises a first and a second multimode interferometer each optically coupled to a first and a second input waveguide arm and to a first and a second output waveguide arm. A first and a second multimode phase shifter respectively interconnect the first interferometer's first output arm and the second interferometer's first input arm, and the first interferometer's second output arm and the second interferometer's second input arm. At least a third phase shifter is optically coupled to one of the second interferometer's output and the first interferometer's input. Each phase shifter is configured to impart respective phase shifts to optical modes of an optical wave.

### CROSS-REFERENCE TO RELATED APPLICATIONS

The present application claims the benefit of U.S. Provisional Patent Application No. 63/470,617 filed on Jun. 2, 2023, the contents of which are hereby incorporated by reference.

### FIELD

The improvements generally relate to the field of optoelectronic computing systems, and more particularly to programmable quantum processors.

### BACKGROUND

Quantum computing has rapidly evolved since the beginning of the twenty-first century, as inventors begun to design systems that implement theoretical concepts of quantum mechanics. One can think of the creation and the use of quantum bits (qubits) as being a major breakthrough in the field. While various ways to create and manipulate qubits have been developed (e.g. by polarizing light, controlling the spin of electrons and the like), efforts are nowadays invested for large-scale production of quantum computers.

Silicon photonics (SiPh) has been particularly prominent in the development of quantum processors as it offers compatibility with complementary metal oxide semiconductor (CMOS), which leads to high density and low-cost manufacturing. By manipulating the transverse modes of single photons in path-encoded programmable quantum gates, recent designs of quantum operators have been developed, such as controlled-NOT (CNOT) gates. Yet, most designs created so far lack programmability and tunability, which limits the processing potential of quantum computers.

Therefore, there is a need for improvement.

### SUMMARY

In accordance with one aspect, there is provided a quantum processing unit comprising a first multimode interferometer and a second multimode interferometer each optically coupled to a first and a second input waveguide arm at an input thereof and to a first and a second output waveguide arm at an output thereof, a first multimode phase shifter interconnecting the first output waveguide arm of the first multimode interferometer and the first input waveguide arm of the second multimode interferometer, the first multimode phase shifter configured to impart first respective phase shifts to optical modes of a first optical wave received at the first input waveguide arm of the first multimode interferometer and propagating in the first output waveguide arm of the first multimode interferometer, a second multimode phase shifter interconnecting the second output waveguide arm of the first multimode interferometer and the second input waveguide arm of the second multimode interferometer, the second multimode phase shifter configured to impart second respective phase shifts to optical modes of a second optical wave received at the second input waveguide arm of the first multimode interferometer and propagating in the second output waveguide arm of the first multimode interferometer, and at least a third multimode phase shifter optically coupled to one of the output of the second multimode interferometer and the input of the first multimode interferometer, the third multimode phase shifter configured to impart third respective phase shifts to optical modes of a third optical wave propagating at the one of the output of the second multimode interferometer and the input of the first multimode interferometer.

In some embodiments, the quantum processing unit further comprises a first mode exchanger interposed between the second output waveguide arm of the first multimode interferometer and an input of the second multimode phase shifter, the first mode exchanger configured to perform a conversion between the optical modes of the second optical wave.

In some embodiments, the quantum processing unit further comprises a second mode exchanger interposed between the first output waveguide arm of the first multimode interferometer and an input of the first multimode phase shifter, the second mode exchanger configured to perform a conversion between the optical modes of the first optical wave.

In some embodiments, the first phase shifter, the second phase shifter, and the third phase shifter each comprise a mode sensitive phase shifter and a mode insensitive phase shifter arranged in a cascade configuration, the mode insensitive phase shifter configured to impart a same phase shift to the optical modes and the mode sensitive phase shifter configured to impart a different phase shift to the optical modes.

In some embodiments, the optical modes comprise a fundamental quasi-transverse electric (TE0) mode and a first order quasi-transverse electric (TE1) mode.

In some embodiments, the optical modes comprise a fundamental transverse magnetic (TM0) mode and a first order transverse magnetic (TM1) mode.

In some embodiments, the quantum processing unit further comprises at least one controller connected to each of the first phase shifter, the second phase shifter, and the third phase shifter, the at least one controller configured to apply a first Direct Current (DC) bias to the first phase shifter, a second DC bias to the second phase shifter, and a third DC bias to the third phase shifter for controlling values of the first phase shifts, the second phase shifts, and the third phase shifts.

In some embodiments, each of the first phase shifter, the second phase shifter, and the third phase shifter is a multi-transverse-mode thermo-optic phase shifter.

In some embodiments, the first phase shifter, the second phase shifter, and the third phase shifter are configured for independently imparting the first phase shifts, the second phase shifts, and the third phase shifts to the optical modes to encode one or more qubits using single photons provided at the first and the second input waveguide arm of the first multimode interferometer.

In some embodiments, the third multimode phase shifter is optically coupled to the first output waveguide arm of the second multimode interferometer and is configured to impart the third respective phase shifts to optical modes of the third optical wave propagating in the first output waveguide arm of the second multimode interferometer.

In some embodiments, the quantum processing unit further comprises a fourth multimode phase shifter optically coupled to the second output waveguide arm of the second multimode interferometer and configured to impart fourth respective phase shifts to optical modes of a fourth optical wave propagating in the second output waveguide arm of the second multimode interferometer.

In some embodiments, the third multimode phase shifter is optically coupled to the first input waveguide arm of the first multimode interferometer and is configured to impart the third respective phase shifts to optical modes of the third optical wave propagating in the first input waveguide arm of the first multimode interferometer, the quantum processing unit further comprising a fourth multimode phase shifter optically coupled to the second input waveguide arm of the first multimode interferometer and configured to impart fourth respective phase shifts to optical modes of a fourth optical wave propagating in the second input waveguide arm of the first multimode interferometer.

In accordance with another aspect, there is provided a quantum processing system comprising an interconnected plurality of the quantum processing unit arranged in one of a Reck mesh configuration, a Diamond mesh configuration, a Clements mesh configuration, and a Bokun mesh configuration.

In accordance with yet another aspect, there is provided a method for configuring the quantum processing unit, comprising (a) applying a first Direct Current (DC) bias to the first phase shifter, a second DC bias to the second phase shifter, and at least a third DC bias to at least the third phase shifter to control the first phase shifts, the second phase shifts, and at least the third phase shifts, (b) providing photons to the first and the second input waveguide arms of the first multimode interferometer, (c) measuring the optical modes at an output of the quantum processing unit, the optical modes as measured indicative of actual values of the first phase shifts, the second phase shifts, and at least the third phase shifts, (d) comparing, based on the optical modes as measured, the actual values of the first phase shifts, the second phase shifts, and at least the third phase shifts to target values, and (e) when the actual values of the first phase shifts, the second phase shifts, and at least the third phase shifts deviate from the target values, adjusting at least one of the first DC bias, the second DC bias, and at least the third DC bias and repeating steps (b) to (e).

In some embodiments, the first DC bias, the second DC bias, and at least the third DC bias are applied to cause the quantum processing unit to be in one of an Hadamard gate configuration, a CNOT gate configuration, a CPhase gate configuration, and a Pauli gate configuration.

In accordance with yet another aspect, there is provided a method for providing a quantum processing unit, comprising providing a first multimode interferometer and a second multimode interferometer, optically coupling an input of each of the first multimode interferometer and the second multimode interferometer to a first and a second input waveguide arm, and an output of each of the first multimode interferometer and the second multimode interferometer to a first and a second output waveguide arm, interconnecting the first output waveguide arm of the first multimode interferometer and the first input waveguide arm of the second multimode interferometer via a first multimode phase shifter, the first multimode phase shifter configured to impart first respective phase shifts to optical modes of a first optical wave received at the first input waveguide arm of the first multimode interferometer and propagating in the first output waveguide arm of the first multimode interferometer, interconnecting the second output waveguide arm of the first multimode interferometer and the second input waveguide arm of the second multimode interferometer via a second multimode phase shifter, the second multimode phase shifter configured to impart second respective phase shifts to optical modes of a second optical wave received at the second input waveguide arm of the first multimode interferometer and propagating in the second output waveguide arm of the first multimode interferometer, and optically coupling one of the output of the second multimode interferometer and the input of the first multimode interferometer with at least a third multimode phase shifter, the third multimode phase shifter configured to impart third respective phase shifts to optical modes of a third optical wave propagating at the one of the output of the second multimode interferometer and the input of the first multimode interferometer.

In some embodiments, the third multimode phase shifter is optically coupled to the first output waveguide arm of the second multimode interferometer and is configured to impart the third respective phase shifts to optical modes of the third optical wave propagating in the first output waveguide arm of the second multimode interferometer.

In some embodiments, the method further comprises optically coupling a fourth multimode phase shifter to the second output waveguide arm of the second multimode interferometer, the fourth multimode phase shifter configured to impart fourth respective phase shifts to optical modes of a fourth optical wave propagating in the second output waveguide arm of the second multimode interferometer.

In some embodiments, the third multimode phase shifter is optically coupled to the first input waveguide arm of the first multimode interferometer and is configured to impart the third respective phase shifts to optical modes of the third optical wave propagating in the first input waveguide arm of the first multimode interferometer, the method further comprising optically coupling a fourth multimode phase shifter to the second input waveguide arm of the first multimode interferometer, the fourth multimode phase shifter configured to impart fourth respective phase shifts to optical modes of a fourth optical wave propagating in the second input waveguide arm of the first multimode interferometer.

In some embodiments, the method further comprises arranging a mode sensitive phase shifter and a mode insensitive phase shifter in a cascade configuration to form each of the first phase shifter, the second phase shifter, and the third phase shifter, the mode insensitive phase shifter configured to impart a same phase shift to the optical modes and the mode sensitive phase shifter configured to impart a different phase shift to the optical modes.

Many further features and combinations thereof concerning embodiments described herein will appear to those skilled in the art following a reading of the instant disclosure.

### DESCRIPTION OF THE FIGURES

In the figures,

FIG. 1 is a schematic diagram of a 4×4 scalable transverse-mode-encoded quantum processing unit, in accordance with an illustrative embodiment;

FIG. 2A is a schematic diagram of a thermo-optic phase shifter (TOPS) for use in the quantum processing unit of FIG. 1, in accordance with an illustrative embodiment;

FIG. 2B is an electron microscopy image of a mode sensitive waveguide of a phase shifter of FIG. 2A, in accordance with an illustrative embodiment;

FIG. 2C is an electron microscopy image of a mode exchanger for use in the quantum processing unit of FIG. 1, in accordance with an illustrative embodiment;

FIGS. 3A, 3B, 3C, and 3D are schematic diagrams of a 4×4 scalable transverse-mode-encoded quantum processing unit, in accordance with various illustrative embodiments;

FIG. 4 is a schematic diagram of a 8×8 transverse mode encoded programmable quantum processor using a plurality of the quantum processing unit of FIG. 1, in accordance with an illustrative embodiment;

FIG. 5 is a flowchart of a method for providing the quantum processing unit of FIG. 1, in accordance with an illustrative embodiment;

FIG. 6 is a flowchart of a method for configuring the quantum processing unit of FIG. 1, in accordance with an illustrative embodiment; and

FIG. 7 is a block diagram of an example computing device, in accordance with an illustrative embodiment.

### DETAILED DESCRIPTION

Described herein is a scalable multi-transverse-mode quantum processing unit (also referred to as a “quantum processing unit” herein). As will be described further below, the proposed quantum processing unit exploits multiple optical modes. In one embodiment, the proposed quantum processing unit exploits multiple quasi-transverse electric (TE) orthogonal optical modes, namely the fundamental TE mode (TE0) and the first TE mode (TE1). In particular and as will also be described further below, in one embodiment, the proposed quantum processing unit receives two optical waves, each optical wave having a TE0 mode and a TE1 mode, and outputs two optical waves having phase shifts imparted to the TE0 mode and to the TE1 mode. The proposed quantum processing unit may indeed be configured to impart phase shifts independently to the TE0 and TE1 modes by employing at least three phase shifters. This, may in turn, enable to arbitrary input quantum states into the resulting quantum processor without the need for prior state preparation. The proposed quantum processing unit may be used for large-scale photonic quantum computing and quantum sensing applications.

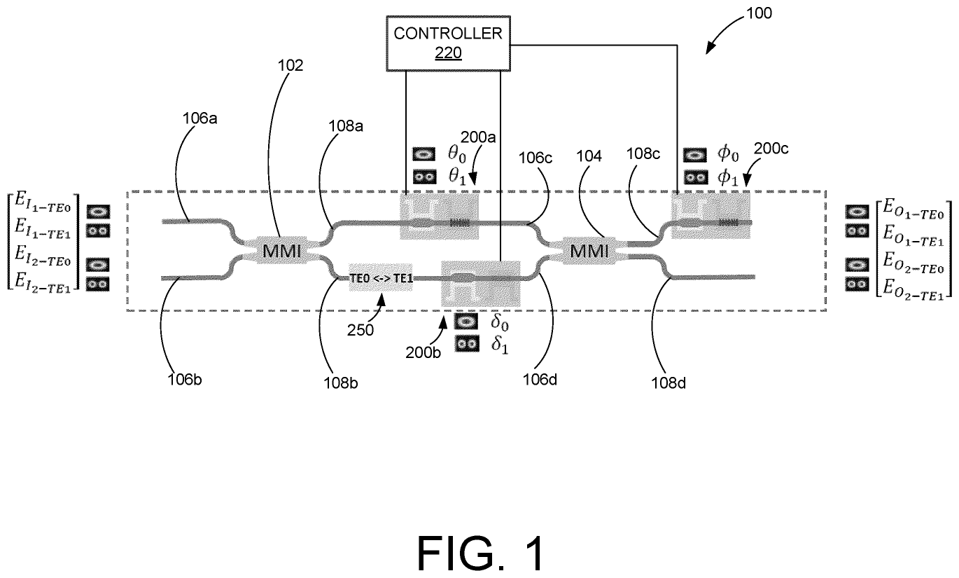

Referring to FIG. 1, an example 4×4 scalable transverse-mode-encoded quantum processing unit 100 will now be described, in accordance with an illustrative embodiment. The quantum processing unit 100 comprises two multimode interferometers (MMI) 102, 104. The first MMI 102 has two input optical waveguide arms 106a, 106b, and two output optical waveguide arms 108a, 108b. The second MMI 104 has two input optical waveguide arms 106c, 106d, and two output optical waveguide arms 108c, 108d. It will be appreciated that the input waveguide arms 106a, 106b of the first MMI 102 are configured to each receive a respective input optical wave (e.g., in the form of an optical input vector [I₀ I₁] of input optical signals), having a first optical mode and a second optical mode. In one embodiment, the first optical mode is the fundamental quasi-transverse electric (or TE0) mode and the second optical mode is the first order quasi-transverse electric (or TE1) mode. Similarly, the output waveguide arms 108c, 108d of the second MMI 104 are configured to each output a respective output optical wave (e.g., in the form of an optical output vector [O₀ O₁] of output optical signals), having the first optical mode and the second optical mode (e.g., the TE0 mode and the TE1 mode) with phase shifts imparted thereto, as will be described further below.

While reference is made herein to independently imparting phase shifts on two optical modes, i.e. the TE0 and TE1 modes, for encoding qubits in a quantum processor, it should be understood that other embodiments may apply. For example, in some embodiments, more than two TE modes may propagate within the quantum processing unit 100, which may in turn be configured to impart phase shifts on more than two TE modes for encoding a plurality of qubits. In other embodiments, the quantum processing unit 100 may be configured to impart phase shifts on transverse magnetic (TM) modes (e.g., a fundamental TM mode or TM0, and a first order TM more or TM1) rather than (or in addition to) TE modes.

As understood by those skilled in the art, the MMIs 102, 104 are micro-scale structures in which photons can propagate, with a probabilistic way of directing towards each output. In one embodiment, the MMIs 102, 104 are 50-50 beam splitters and their interconnection forms a Mach-Zehnder interferometer (MZI). While reference is made herein to the quantum processing unit 100 comprising MMIs 102, 104, it should however be understood that any building block configured to split an optical wave (e.g., using a 50:50 splitting ratio or any other suitable splitting ratio) may apply. For example, in some embodiments, Y-junctions may be used. Other embodiments may apply.

In some embodiments, the quantum processing unit 100 encodes quantum information (i.e. qubits) using single photons. While the technology is not bound to any particular single photon source, it will be appreciated that a faint laser, i.e. a light source emitting a laser beam of low intensity, can be used to generate single photons.

In some embodiments, two adiabatic directional coupler-based mode multiplexer/demultiplexers (MUX/deMUX, not shown) may be used for merging the TE0 and the TE1 modes upon entering the first MMI 102 and for separating the TE0 and TE1 modes upon exiting the second MMI 104. It will be appreciated that the MUX/deMux converts between path-encoded qubits and transverse mode-encoded qubits in a similar way that a polarization beam splitter/combiner converts between polarization-encoded qubits and path-encoded ones. In some embodiments, the waveguide arms 106a, 106b, 106c, 106d, 108a, 108b, 108c, 108d are multimode waveguides of about 0.96 μm wide, allowing the propagation of TE0 and TE1 modes. Any other suitable size or dimension may apply for the waveguide arms 106a, 106b, 106c, 106d, 108a, 108b, 108c, 108d.

The quantum processing unit 100 further comprises at least three phase shifter units 200a, 200b, 200c. In one embodiment, the phase shifter units 200a, 200b, 200c are thermo-optic phase shifters (TOPS). As understood by those skilled in the art, a thermo-optic phase shifter operates by heating a waveguide to change the waveguide's refractive index. While reference is made herein to TOPS being used in the proposed quantum processing unit 100, it should be understood that any other suitable phase shifter including, but not limited to, an electro-optic phase shifter that operates by applying an electric field or electrical current to change the waveguide's refractive index, thereby imparting different phase shifts to different modes, may apply.

In the embodiment illustrated in FIG. 1, the phase shifter unit 200a interconnects the first output waveguide arm 108a of the first MMI 102 and the first input waveguide arm 106c of the second MMI 104, the phase shifter unit 200b interconnects the second output waveguide arm 108b of the first MMI 102 and the second input waveguide arm 106d of the second MMI 104, and the phase shifter unit 200c is connected to the first output waveguide arm 108c of the second MMI 104. The interconnection of MMI 102 and MMI 104 thus forms a Mach-Zehnder interferometer (MZI). It will be appreciated that the terms “interconnected”, “coupled”, “optically coupled”, and “connected”, as used herein, imply that an optical connection is made between components such that an optical wave is able to propagate. The terms “interconnected” and “connected” may imply both direct coupling (in which two elements that are coupled to each other contact each other) and indirect coupling (in which at least one additional element is located between the two elements).

The phase shifter units 200a, 200b, 200c are each configured to impart a first phase shift (respectively θ₀, δ₀, and φ₀) on the first optical mode (e.g., TE0) and a second phase shift (respectively θ₁, δ₁, and φ₁) on the second optical mode (e.g., TE1). In some embodiments, each phase shifter unit 200a, 200b, 200c comprises two cascaded phase shifters (e.g., a mode-insensitive phase shifter followed by a mode-sensitive phase shifter). As will be described further below, this allows to independently impart phase shifts on the TE0 and TE1 modes.

As used herein, the term “mode insensitive”, as opposed to the term “mode sensitive”, refers to the fact that a given device (e.g., a phase shifter) is insensitive to the TE mode propagating through the waveguide arm the device is provided on. For instance, a mode insensitive phase shifter applies a same phase shift to different TE modes such that both TE0 and TE1 modes travel through the phase shifter with the same speed. In contrast, the term “mode sensitive” refers to the fact that a given device (e.g., a phase shifter) is sensitive to the TE mode propagating through the waveguide arm the device is provided on. For instance, a mode sensitive phase shifter applies different phase shifts to different TE modes such that the 275 group velocity of TE0 and TE1 modes propagating through the phase shifter is different.

At least one controller (one of which, controller 220, is shown in FIG. 1 for sake of illustration) may be connected to each of the phase shifter units 200a, 200b, 200c (and particularly to the mode-insensitive and mode-sensitive phase shifters thereof) so that particular values of the phase shifts φ₀, θ₀, δ₀, φ₁, θ₁, and δ₁ may be set for a given configuration of the quantum processing unit 100. For instance, direct current (DC) bias voltages (or currents) corresponding to defined values of the phase shifts φ₀, θ₀, δ₀, φ₁, θ₁, and δ₁ may be provided by the controller(s) as in 220 to the phase shifter units 200a, 200b, 200c for programming the quantum processing unit 100 in order to cause a unitary transformation on the optical fields of the two optical paths and two optical modes.

In some embodiments, a mode exchanger 250 interconnects the second output waveguide arm 108b of the first MMI 102 and the phase shifter unit 200b. The mode exchanger is configured to convert the TE0 mode received at an input of the mode exchanger 250 (i.e. via output waveguide arm 108b) to the TE1 mode which is provided at an output of the mode exchanger 250 (i.e. to the phase shifter unit 200b), and vice versa (i.e. convert the TE1 mode received at the input of the mode exchanger 250 to the TE0 mode which is provided at the output of the mode exchanger 250). The mode exchanger 250 may in turn improve the performance of the quantum processing unit 100 by allowing transmission between different TE modes. It should however be understood that the mode exchanger 250 may be omitted in some embodiments.

The quantum processing unit 100 may be represented in a matrix format, as per equation (1) below:

$$[ \begin{matrix}{E}_{01 - TE 0} \\ {E}_{01 - TE 1} \\ {E}_{02 - TE 0} \\ {E}_{02 - TE 1}\end{matrix} ] = A \times B \times C \times D \times E \times [ \begin{matrix}{E}_{01 - TE 0} \\ {E}_{01 - TE 1} \\ {E}_{02 - TE 0} \\ {E}_{02 - TE 1}\end{matrix} ] \qquad ( 1 )$$

$$where :$$

$$A = [ \begin{matrix}{e}^{j {ϕ}_{0}} & 0 & 0 & 0 \\ 0 & {e}^{j {ϕ}_{0}} & 0 & 0 \\ 0 & 0 & 1 & 0 \\ 0 & 0 & 0 & 1\end{matrix} ] ; B = [ \begin{matrix}\sqrt{ρ} & 0 & j \sqrt{1 - ρ} & 0 \\ 0 & \sqrt{ρ} & 0 & j \sqrt{1 - ρ} \\ j \sqrt{1 - ρ} & 0 & \sqrt{ρ} & 0 \\ 0 & j \sqrt{1 - ρ} & 0 & \sqrt{ρ}\end{matrix} ] ;$$

$$C = [ \begin{matrix}{e}^{j {θ}_{0}} & 0 & 0 & 0 \\ 0 & {e}^{j {θ}_{1}} & 0 & 0 \\ 0 & 0 & {e}^{j {δ}_{0}} & 0 \\ 0 & 0 & 0 & {e}^{j {δ}_{1}}\end{matrix} ] ; D = [ \begin{matrix}1 & 0 & 0 & 0 \\ 0 & 1 & 0 & 0 \\ 0 & 0 & 0 & 1 \\ 0 & 0 & 1 & 0\end{matrix} ] ; and$$

$$E = [ \begin{matrix}\sqrt{ρ} & 0 & j \sqrt{1 - ρ} & 0 \\ 0 & \sqrt{ρ} & 0 & j \sqrt{1 - ρ} \\ j \sqrt{1 - ρ} & 0 & \sqrt{ρ} & 0 \\ 0 & j \sqrt{1 - ρ} & 0 & \sqrt{ρ}\end{matrix} ] ,$$

and where E_{1x-TEy} is the optical field at the x^{th} input and y^{th} TE mode, and E_{0x-TEy} is the optical field at the x^{th} output and y^{th} TE mode. ρ is the optical power splitting ratio of the MMIs 102, 104, which may be equal for TE0 and TE1 due to the mode independence behavior of the MMIs 102 and 104. φ₀, θ₀, and δ₀ are the phase shifts applied to TE0 and φ₁, θ₁, and δ₁ are the phase shifts applied to TE1 by the phase shifter units 200a, 200b, 200c, respectively.

The transfer matrices of equation (1) are representative of components of the quantum processing unit 100 illustrated in FIG. 1. For instance, matrix A corresponds to phase shifter unit 200c, matrix B corresponds to the second MMI 104, matrix C corresponds to both phase shifter units 200a, 200b, matrix D corresponds to the mode exchanger 250, and matrix E corresponds to the first MMI 102. It will be appreciated that the matrices A, B, C, D, and E presented above are specific to the embodiment illustrated in FIG. 1, and that the matrices used in equation (1) may vary depending on the configuration of the quantum processing unit and on the application.

For ρ=0.5, the linear transformation matrix of the input optical field to the output optical field can be expressed as follows:

$$R = \frac{1}{2} x [ \begin{matrix}{e}^{j {ϕ}_{0} + j {θ}_{0}} & - {e}^{j {ϕ}_{0} + j {δ}_{0}} & {je}^{j {ϕ}_{0} + j {θ}_{0}} & {je}^{j {ϕ}_{0} + j {δ}_{0}} \\ - {e}^{j {ϕ}_{1} + j {δ}_{1}} & {e}^{j {ϕ}_{1} + j {θ}_{1}} & j {e}^{j {ϕ}_{1} + j {δ}_{1}} & j {e}^{j {ϕ}_{1} + j {θ}_{1}} \\ j {e}^{j {θ}_{0}} & j {e}^{j {δ}_{0}} & - {e}^{j {θ}_{0}} & {e}^{j {δ}_{0}} \\ {je}^{j {δ}_{1}} & {e}^{j {θ}_{1}} & {e}^{j {δ}_{1}} & {e}^{j {θ}_{1}}\end{matrix} ] \qquad ( 2 )$$

By modifying the values of the phase shifts (φ₀, θ₀, δ₀, φ₁, θ₁, and δ₁) applied by the phase shifter units 200a, 200b, 200c using suited DC bias voltages (or currents), a unitary transformation on the optical fields of the two paths and two orthogonal modes is possible using matrix R. In particular and as mentioned above, the quantum processing unit 100 may be controlled (i.e., may be configured, tuned or programmed) using a suitable processing device, such as at least one controller as in 220. Using the controller 220, DC biases (e.g., different voltages or currents) can be provided to the phase shifter units 200a, 200b, 200c so that different phase shifts φ₀, θ₀, δ₀, φ₁, θ₁, and δ₁ are imparted to the transverse mode of the optical wave to transform the linear transformation matrix R into a matrix characteristic of (i.e. cause the processing unit 100 to be in) one of an Hadamard gate, a CNOT gate, a CPhase gate, a Pauli gate, and the like.

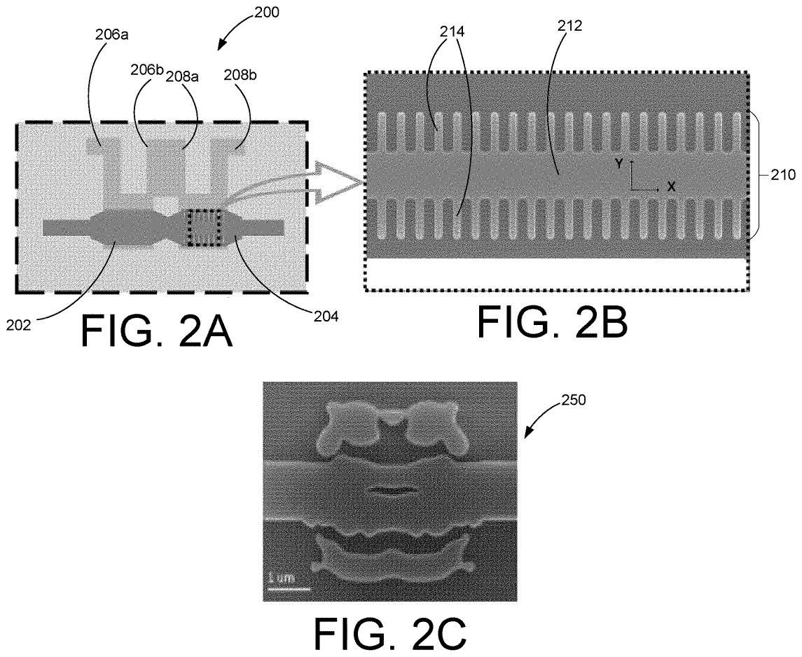

Now referring to FIG. 2A, there is presented a schematic diagram of a TOPS 200, in accordance with an illustrative embodiment. The TOPS 200 comprises a mode-insensitive phase shifter 202 and mode-sensitive phase shifter 204 arranged in a cascade configuration. The mode-insensitive phase shifter 202 and the mode-sensitive phase shifter 204 are provided with electrical contacts 206a, 206b and electrical contacts 208a, 208b, respectively. The electrical contacts 206a, 206b, 208a, 208b are used to apply an electrical bias voltage (or current), also referred to herein as a “DC bias”, to the phase shifters 202, 204 in order to impart a phase shift to the TE0 and TE1 modes, depending on an applied DC bias voltage or current (e.g., provided by at least one controller, reference 220 in FIG. 1). As illustrated in FIG. 1, in the TE0 mode, most of the optical electric field (E) is positioned at the center of the waveguide and the optical electric field distribution has a substantially elliptic shape. In contrast, in the TE1 mode, the optical electric field is split into two peaks (or side lobes) positioned close to the sidewall of the waveguide and the optical electric field distribution is substantially shaped as two lobes. Therefore, both the TE0 mode and the TE1 mode have a respective position in the propagation plane of the optical wave.

Still referring to FIG. 2A, in one embodiment, the mode-insensitive phase shifter comprises a waveguide (not shown) interconnecting the electrical contacts 206a, 206b, the waveguide having a width greater than 4 μm. In the mode-insensitive phase shifter 202 of FIG. 2A, both TE0 and TE1 modes propagate through a medium having a substantially uniform thermo-optic coefficient. The thermo-optic coefficient of the medium may indeed vary by at most 2% within the waveguide. Such a structure enables to impart phase shifts to both the TE0 and the TE1 modes with minimal variations through the waveguide used to implement the mode-insensitive phase shifter 202. As can be seen in FIG. 2A and FIG. 2B, the mode-sensitive phase shifter 204 is designed so as to comprise a first medium allowing propagation of the TE0 mode and a second medium allowing propagation of the TE1 mode. This enables the mode-insensitive phase shifter 202 to impart different phase shifts to the TE0 mode and the TE1 mode.

As illustrated in FIG. 2B, in one embodiment, the mode-sensitive phase shifter 204 comprises a waveguide 210 having a ladder shape. The waveguide 210 comprises an elongated center portion 212 extending along a direction X, and a plurality of side portions 214 each extending away from the center portion 212 along a direction Y substantially perpendicular to direction X, the plurality of side portions 214 being spaced from one another, thus forming the ladder shape. The center portion 212 of the waveguide 210 thus forms a uniform medium while the side portions 214 of the waveguide 210 form a grating made of an interleaved sequence of two different media. In some embodiments, the side portions 214 of the ladder-shaped waveguide 210 form a subwavelength grating (SWG) structure, in which the thickness of the side portions as in 214 and the space between side portions as in 214 is lower than the wavelength of the optical wave propagating through the mode-sensitive phase shifter 204. In this configuration, the TE0 mode propagates in the center portion 212 of the waveguide while the TE1 mode propagates in the side portions 214 of the waveguide. Since the TE0 and TE1 modes propagate in different media, the phase shift imparted by the mode-sensitive phase shifter 204 on the TE0 mode is different from the phase shift imparted by the mode-sensitive phase shifter 204 on the TE1 mode. It should however be understood that the waveguide 210 may have any suitable shape, geometry, or configuration other than the ladder 375 shape illustrated in FIG. 2 and described herein. For example, the waveguide 210 may have a circular shape, a triangular shape, or the like. In some embodiments, the waveguide 210 has a non-conventional inverse designed shape.

In some embodiments, the mode-insensitive phase shifter 202 imparts a phase shift of α to the TE0 and TE1 modes, while the mode-sensitive phase shifter 204 imparts a phase shift of k×β (where k is a multiplier being a positive real number not equal to 1) to the TE0 mode and the mode-sensitive phase shifter 204 imparts a phase shift of β to the TE1 mode. Thus, the phase shift imparted by the TOPS 200 to the TE0 mode is equal to α+k×β and the phase shift imparted by the TOPS 200 to the TE1 mode is equal to α+β. It will be understood that the values of α and β may vary according to the DC bias voltage (or current) applied to the TOPS 200 (e.g., by a controller as in 220 of FIG. 1). In one embodiment, the multiplier k has a value of 1.2 such that the mode-sensitive phase shifter 204 imparts to the TE0 mode a phase shift of 1.2×β. In another embodiment, the multiplier k has a value of 1.4 such that the mode-sensitive phase shifter 204 imparts a phase shift of 1.4×β to the TE0 mode. In yet another embodiment, the multiplier k has a value of 1.5 such that the mode-sensitive phase shifter 204 imparts a phase shift of 1.5×β to the TE0 mode. It should be understood that the value of the phase shifts α and β, as well as the vale of the multiplier k, may vary depending on the configuration of the quantum processing unit 100 and on the application. However, it may be desirable to use a mode-sensitive phase shifter 204 having a multiplier k as large as possible in order to impart a larger phase shift to the TE0 mode than the phase shift imparted to the TE1 mode.

In other embodiments, the mode-insensitive phase shifter 202 may be replaced with a second mode-sensitive phase shifter having a multiplier k₂, (with the mode-sensitive phase shifter 204 having a multiplier k₁ different from k₂), thereby imparting a phase shift of k₂×α to the TE0 mode and a phase shift of α to the TE1 mode. Thus, using such a cascade of two mode-sensitive phase shifters 202, 204, the overall phase shift imparted to the TE0 mode is k₂×α+k₁×β and the overall phase shift imparted to the TE1 mode is α+β. In these embodiments, it may be desirable for the multiplier k₂ to be as large as possible so that the phase shift imparted to the TE0 mode is maximized.

In yet other embodiments, the mode insensitive phase shifter 202 may be replaced with a third mode-sensitive phase shifter having a multiplier m different from the multiplier k of the mode-sensitive phase shifter 204. In these embodiments, the mode insensitive phase shifter 202 is configured to impart a phase shift of α on the TE0 mode and a phase shift of m×α on the TE1 mode. It will be appreciated that, in these embodiments, the multiplier m may have as small of a value as possible relative to the value of the multiplier k (e.g., m smaller than 1 and k larger than 1) so that the difference between the phase shifts imparted to the TE0 and TE1 is maximized.

In other embodiments, the position of the mode-sensitive phase shifter 202 and the mode-insensitive phase shifter 204 is reversed, meaning that light first enters the mode-insensitive phase 204 shifter before entering the mode-sensitive phase shifter 202.

In some embodiments, the waveguide used to implement the mode-insensitive phase shifter 202 and the mode-sensitive phase shifter 204 is made of silicon (Si) having a thermo-optic coefficient of about 1.86×10⁻⁴ K⁻¹ and the waveguide wall is made of silicon oxide (SiO₂) having a thermo-optic coefficient of about 0.95×10⁻⁵ K⁻¹. Other embodiments may apply.

FIG. 2C illustrates an embodiment of the mode exchanger 250. Using the illustrated topology, which is designed to reduce footprint, the mode exchanger 250 may be configured to realize the same phase shift for both TE0 and TE1 modes, by exchanging the optical modes midway within the mode exchanger 250.

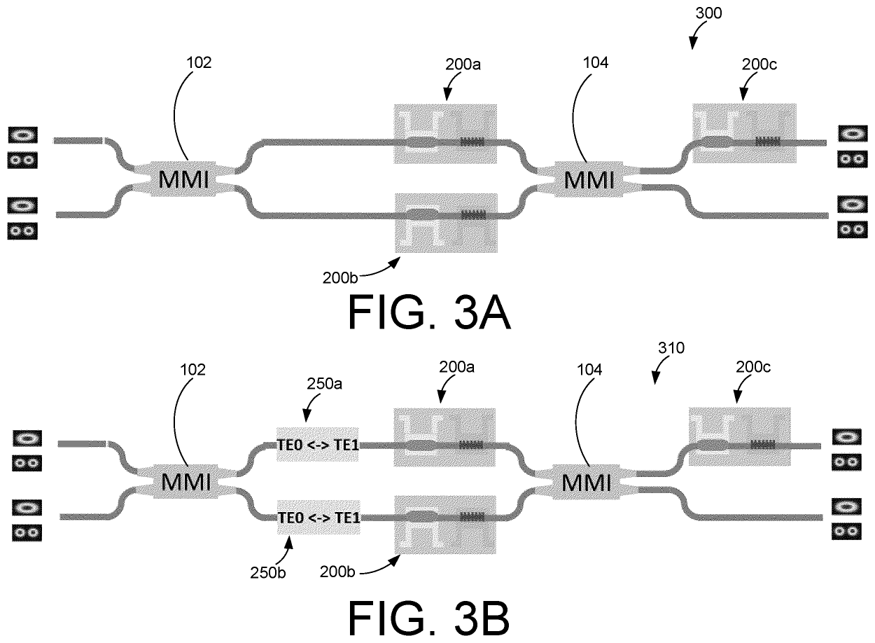

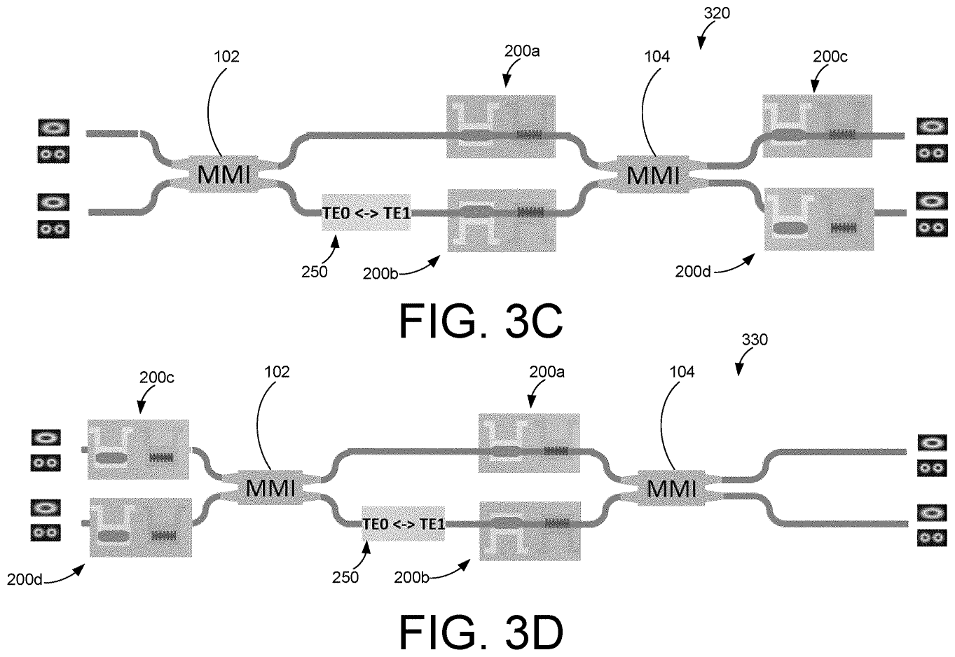

FIGS. 3A-3D depict alternate embodiments of a 4×4 scalable transverse-mode-encoded quantum processing unit. Each quantum processing unit illustrated in FIGS. 3A-3D comprises a plurality of phase shifter unit each configured to impart a first phase shift on the first optical mode, e.g. TE0, and a second phase shift on the second optical mode, e.g. TE1, propagating through the quantum processing unit.

FIG. 3A illustrates a quantum processing unit 300 having two MMIs 102, 104 and three phase shifter units 200a, 200b, 200c. The phase shifter units 200a, 200b interconnect the output waveguide arms of the first MMI 102 and the input waveguide arms of the second MMI 104, and the phase shifter unit 200c connects with an output waveguide arm of the second MMI 104. In this embodiment, the same TE0 and TE1 modes enter the phase shifter units 200a, 200b.

FIG. 3B illustrates a quantum processing unit 310 having two MMIs 102, 104, three phase shifter units 200a, 200b, 200c and two mode exchangers 250a, 250b. The phase shifter units 200a, 200b interconnect the output waveguide arms of the first MMI 102 and the input waveguide arms of the second MMI 104, and the phase shifter unit 200c connects with an output waveguide arm of the second MMI 104. The mode exchangers 250a, 250b interconnect the output waveguide arms of the first MMI 102 and the phase shifter units 200a, 200b. In particular, the first mode exchanger 250a is coupled to the first output waveguide arm (reference 108a in FIG. 1) of the first MMI 102 and to an input of the phase shifter unit 200a, while the second mode exchanger 250b is coupled to the second output waveguide arm (reference 108b in FIG. 1) of the first MMI 102 and to an input of the phase shifter unit 200b. Similarly to the mode exchanger 250 of FIG. 1, the mode exchangers 250a, 250b are respectively configured to perform a conversion (i.e. a swap or exchange) between the optical modes of the optical waves propagating through the first and second output waveguide arms 108a, 108b. Similarly to the quantum processing unit 300, the same TE0 and TE1 modes enter the phase shifter units 200a, 200b of the quantum processing unit 310.

FIG. 3C illustrates a quantum processing unit 320 having two MMIs 102, 104, four phase shifter units 200a, 200b, 200c, 200d and one mode exchanger 250 (coupled to the second output waveguide arm of the first MMI 102 and to an input of the phase shifter unit 200b). The phase shifter units 200a, 200b interconnect the output waveguide arms of the first MMI 102 and the input waveguide arms of the second MMI 104, and the phase shifter units 200c, 200d connect with the output waveguide arms of the second MMI 104. In particular, the phase shifter unit 200c is optically coupled to the first output waveguide arm (reference 108c in FIG. 1) of the second MMI 104, and the phase shifter unit 200d is optically coupled to the second output waveguide arm (reference 108d in FIG. 1) of the second MMI 104. The phase shifter unit 200c is configured to impart respective phase shifts to the optical modes of the optical wave propagating in the first output waveguide arm of the second MMI 104, while the phase shifter unit 200d is configured to impart respective phase shifts to the optical modes of the optical wave propagating in the second output waveguide arm of the second MMI 104.

FIG. 3D illustrates a quantum processing unit 330 having two MMIs 102, 104, four phase shifter units 200a, 200b, 200c, 200d and one mode exchanger 250 (coupled to the second output waveguide arm of the first MMI 102 and to an input of the phase shifter unit 200b). The phase shifter units 200a, 200b interconnect the output waveguide arms of the first MMI 102 and the input waveguide arms of the second MMI 104, and the phase shifter units 200c, 200d connect with the input waveguide arms of the first MMI 102. In particular, the phase shifter unit 200c is optically coupled to the first input waveguide arm (reference 106a of FIG. 1) of the first MMI 102 and is configured to impart respective phase shifts to the optical modes of the optical wave propagating in this first input waveguide arm. The phase shifter unit 200d is optically coupled to the second input waveguide arm (reference 106b of FIG. 1) of the first MMI 102 and is configured to impart respective phase shifts to the optical modes of the optical wave propagating in this second input waveguide arm.

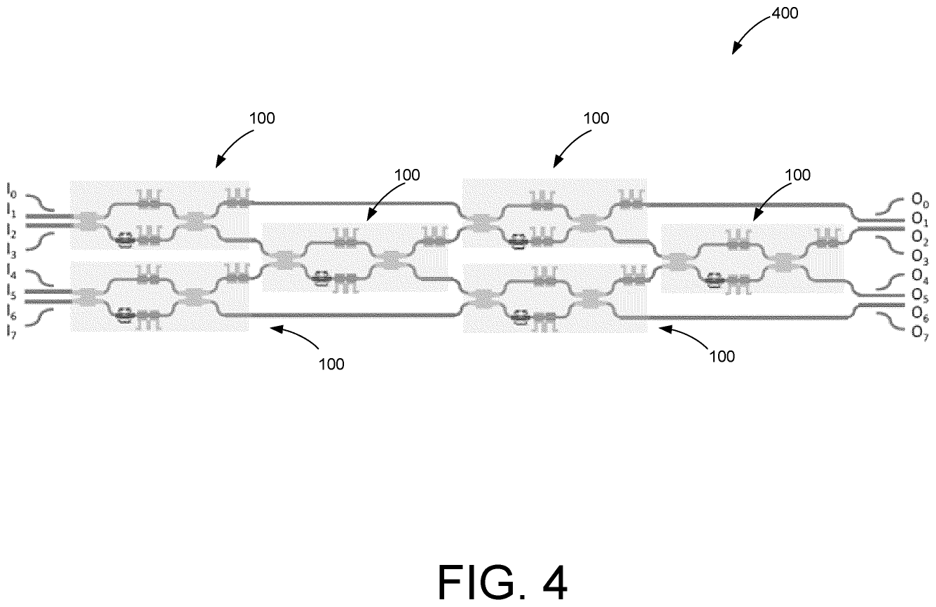

Now referring to FIG. 4, a schematic diagram of an 8×8 transverse mode encoded programmable quantum processor 400 using six (6) quantum processing units 100 of FIG. 1 is illustrated, in accordance with an illustrative embodiment. In some embodiments, the quantum processor 400 imparts a phase shift to N optical modes (or N/2 pairs of TE0 and TE1 modes). The quantum processor 400 presented in FIG. 4 is configured to impart a phase shift to four (4) pairs of TE0 and TE1 modes using six (6) quantum processing units 100. Generally, the number of quantum processing units 100 needed to perform an N×N transformation using a Reck mesh configuration (i.e. a triangular mesh topology of MZIs) or a Clements mesh configuration (as depicted in FIG. 4) is

$$\frac{N ( N - 2 )}{8} .$$

this may provide a more compact design compared to single mode path encoded systems using

$$\frac{N ( N - 2 )}{2}$$

processing units. Thus, the quantum processor 400 may achieve low optical insertion loss and high scalability due to the reduced number of quantum processing units 100 needed to operate the quantum processor 400. While reference is made herein to the Reck mesh and Clements mesh configurations, it will be appreciated that other configurations or topology arrangements for the quantum processor 400 are possible, including, but not limited to, the Diamond mesh configuration (i.e. a symmetrical version of the Reck mesh topology with added MZIs) and the Bokun mesh configuration (i.e. a truncated diamond mesh topology with the middle optical inputs/outputs used as the main optical path).

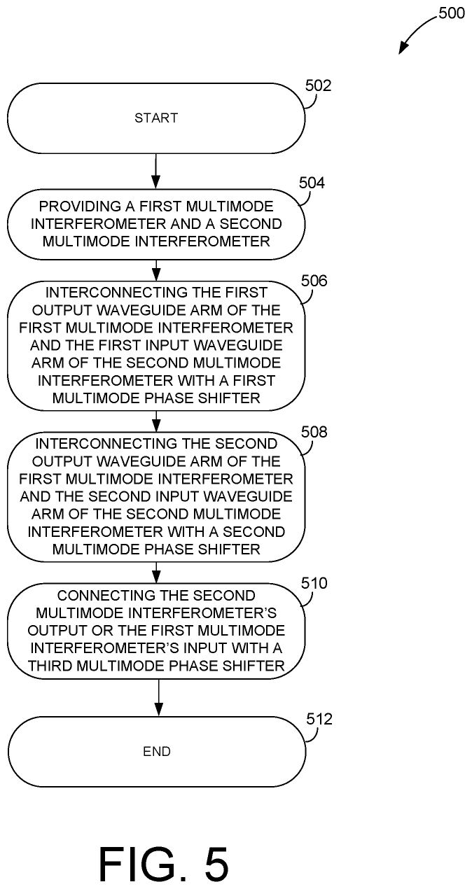

FIG. 5 is a flowchart of a method 500 for providing a quantum processing unit (such as the one illustrated in FIG. 1), in accordance with an illustrative embodiment. Following the start 502 of the method 500, a first multimode interferometer and a second multimode interferometer are provided at step 504. The multimode interferometers may be fabricated in a silicon optical medium, as described herein above. Step 504 may further comprise optically coupling each of the first multimode interferometer and the second multimode interferometer to a first and a second input waveguide arm and to a first and a second output waveguide arm.

At step 506, the first output waveguide arm of the first multimode interferometer and the first input waveguide arm of the second multimode interferometer are interconnected with a first multimode phase shifter. The first multimode phase shifter is configured to impart first respective phase shifts to optical modes of a first optical wave propagating in the first output waveguide arm of the first multimode interferometer. At step 508, the second output waveguide arm of the first multimode interferometer and the second input waveguide arm of 505 the second multimode interferometer are interconnected with a second multimode phase shifter. The second multimode phase shifter is configured to impart second respective phase shifts to optical modes of a second optical wave propagating in the second output waveguide arm of the first multimode interferometer. At step 510, the output (i.e., at least one output waveguide arm) of the second multimode interferometer or the input (i.e. at least one input waveguide arm) of the first multimode interferometer is connected (i.e. optically coupled) with a third multimode phase shifter. The third multimode phase shifter is configured to impart third respective phase shifts to optical modes of a third optical wave propagating at the output of the second multimode interferometer or the input of the first multimode interferometer. As described herein above, in one embodiment, each of the first, the second, and the third optical wave have a first optical mode (e.g., TE0) and a second optical mode (e.g., TE1) associated therewith, such that each of the first, the second, and the third multimode phase shifter is configured to impart one phase shift to the first optical mode and another phase shift to the second optical mode. The method 500 may then end at step 512.

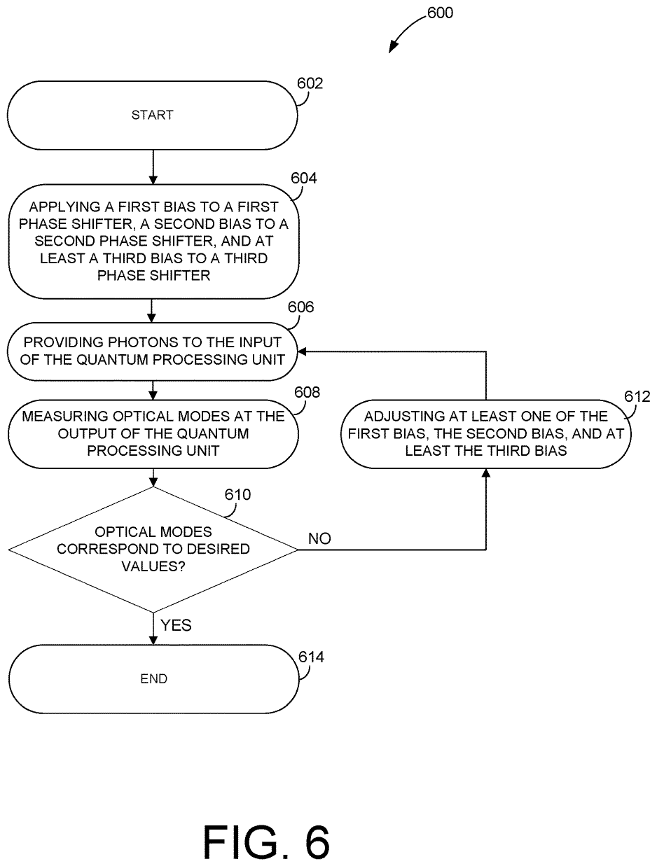

Now referring to FIG. 6, there is shown a flowchart of a method 600 for configuring a quantum processing unit (such as the one illustrated in FIG. 1), in accordance with an illustrative embodiment. Following the start 602 of the method 600, a first bias is applied (i.e. provided) to a first phase shifter (e.g., the phase shifter 200a of FIG. 1) of the quantum processing unit, a second bias is applied to a second phase shifter (e.g., the phase shifter 200b of FIG. 1) of the quantum processing unit, and at least a third bias is applied to at least a third phase shifter (e.g., the phase shifter 200c of FIG. 1) of the quantum processing unit at step 604. In some embodiments, the phase shifters used in the method 600 have the same configuration as the one presented in FIG. 2A, which comprises a mode-insensitive phase shifter and a mode-sensitive phase shifter. Step 604 illustratively comprises finding values of the phase shifts corresponding to a specific linear matrix transformation (e.g., as defined in equation (1) above) and optimizing the first bias, the second bias, and at least the third bias to obtain the linear matrix transformation. The biases provided at step 604 may be the same for the mode-sensitive and the mode-insensitive phase shifters. Alternatively, a respective (i.e. different) bias may be provided to each of the mode-insensitive and the mode-sensitive phase shifters. It will be appreciated that the bias may be a DC bias current or a DC bias voltage. In some embodiments, the values of the biases applied to the phase shifters are determined to configure the quantum processing unit in an intended configuration, e.g., an Hadamard gate configuration, a CNOT gate configuration, a CPhase gate configuration, a Pauli gate configuration, and the like.

Once the biases are set, photons are provided to the input of the quantum processing unit at step 606, e.g., using a suitable photon source. In some embodiments, the photons are provided to the input waveguide arms of the first interferometer illustrated in FIG. 1. It will be appreciated that the photons may be two single photons each associated with two optical modes, e.g. TE0 and TE1 (or TM0 AND TM1), and each being introduced in a respective input waveguide arm of the quantum processing unit.

At step 608, optical modes are measured at the output of the quantum processing unit. In some embodiments, the optical modes are measured at the output of the third phase shifter and at the second output waveguide arm of the second interferometer illustrated in FIG. 1. It will be appreciated that the measurement of the optical modes is representative of actual values of the phase shifts imparted by the phase shifters. Following the measurement at step 608, the next step 610 is to assess whether the measured optical modes (representative of the actual phase shift values) correspond to (i.e. match, within a predetermined tolerance or threshold) target values, i.e. to phase shifts of the intended quantum processor configuration. If it is determined at step 610 that this is not the case, i.e. the optical mode measurement of step 608 indicates that one or more of the actual phase shift values do not correspond to (i.e. deviate from) the target, at least one of the actual values of the first bias, the second bias, and at least the third bias are adjusted (i.e. increased or decreased in order to bring the optical modes towards the target values) at step 612, and steps 606, 608, and 610 are repeated. Once it is determined at step 610 that the measured optical modes correspond to the target values (i.e. that the phase shifts have reached the target values, within the predetermined tolerance or threshold), the method 600 ends at step 614.

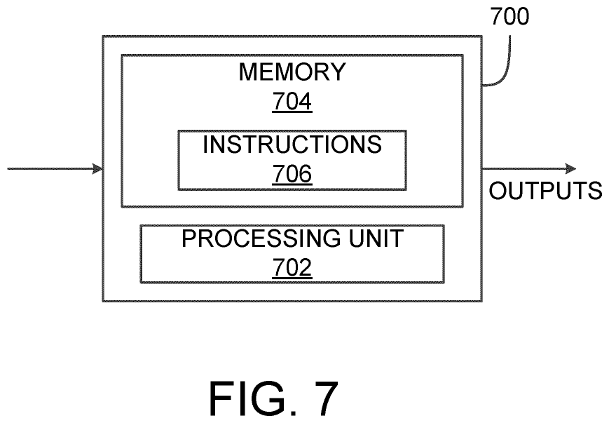

FIG. 7 is a schematic diagram of computing device 700, which may be used to implement a controller (such as the controller 220 of FIG. 1) used to control a quantum processing device (such as the quantum processing units illustrated in FIGS. 1, 3A, 3B, 3C, and 3D) into a specific gate configuration. The computing device comprises a processing unit and a memory 704 which has stored therein computer-executable instructions 706. The processing unit 702 may comprise any suitable devices configured to implement the functionality of the method 600 for configuring the quantum processing unit such that instructions 706, when executed by the computing device 700 or other programmable apparatus, may cause the functions/acts/steps performed by method 600 for configuring the quantum processing unit as described herein to be executed. The processing unit 702 may comprise, for example, any type of general-purpose microprocessor or microcontroller, a digital signal processing (DSP) processor, an integrated circuit, a field programmable gate array (FPGA), a reconfigurable processor, a programmable read-only memory (PROM), or any combination thereof.

The memory 704 may comprise any suitable known or other machine-readable storage medium. The memory 704 may comprise non-transitory computer readable storage medium, for example, but not limited to, an electronic, magnetic, optical, electromagnetic, infrared, or semiconductor system, apparatus, or device, or any suitable combination of the foregoing. The memory 704 may include a suitable combination of any type of computer memory that is located either internally or externally to device, for example random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 704 may comprise any storage means (e.g. devices) suitable for retrievably storing machine-readable instructions 706 executable by the processing unit 702.

In some embodiments, the quantum processing unit described herein may allow to achieve short optical paths due to the minimal quantity of components in the design. In addition, in some embodiments, by employing multi-mode TOPS, the quantum processing unit described herein may achieve independent manipulations of optical modes, enabling programmability and compensation for fabrication variations and dynamic errors. Overall, in some embodiments, the presented design may provide a scalable and versatile platform for quantum information processing.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure.

Various aspects of the systems and methods described herein may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments. Although particular embodiments have been shown and described, it will be apparent to those skilled in the art that changes and modifications may be made without departing from this invention in its broader aspects. The scope of the following claims should not be limited by the embodiments set forth in the examples, but should be given the broadest reasonable interpretation consistent with the description as a whole.

1. A quantum processing unit comprising:
a first multimode interferometer and a second multimode interferometer each optically coupled to a first and a second input waveguide arm at an input thereof and to a first and a second output waveguide arm at an output thereof;
a first multimode phase shifter interconnecting the first output waveguide arm of the first multimode interferometer and the first input waveguide arm of the second multimode interferometer, the first multimode phase shifter configured to impart first respective phase shifts to optical modes of a first optical wave received at the first input waveguide arm of the first multimode interferometer and propagating in the first output waveguide arm of the first multimode interferometer;
a second multimode phase shifter interconnecting the second output waveguide arm of the first multimode interferometer and the second input waveguide arm of the second multimode interferometer, the second multimode phase shifter configured to impart second respective phase shifts to optical modes of a second optical wave received at the second input waveguide arm of the first multimode interferometer and propagating in the second output waveguide arm of the first multimode interferometer; and
at least a third multimode phase shifter optically coupled to one of the output of the second multimode interferometer and the input of the first multimode interferometer, the third multimode phase shifter configured to impart third respective phase shifts to optical modes of a third optical wave propagating at the one of the output of the second multimode interferometer and the input of the first multimode interferometer.

2. The quantum processing unit of claim 1, further comprising a first mode exchanger interposed between the second output waveguide arm of the first multimode interferometer and an input of the second multimode phase shifter, the first mode exchanger configured to perform a conversion between the optical modes of the second optical wave.

3. The quantum processing unit of claim 2, further comprising a second mode exchanger interposed between the first output waveguide arm of the first multimode interferometer and an input of the first multimode phase shifter, the second mode exchanger configured to perform a conversion between the optical modes of the first optical wave.

4. The quantum processing unit of claim 1, wherein the first phase shifter, the second phase shifter, and the third phase shifter each comprise a mode sensitive phase shifter and a mode insensitive phase shifter arranged in a cascade configuration, the mode insensitive phase shifter configured to impart a same phase shift to the optical modes and the mode sensitive phase shifter configured to impart a different phase shift to the optical modes.

5. The quantum processing unit of claim 1, wherein the optical modes comprise a fundamental quasi-transverse electric (TE0) mode and a first order quasi-transverse electric (TE1) mode.

6. The quantum processing unit of claim 1, wherein the optical modes comprise a fundamental transverse magnetic (TM0) mode and a first order transverse magnetic (TM1) mode.

7. The quantum processing unit of claim 1, further comprising at least one controller connected to each of the first phase shifter, the second phase shifter, and the third phase shifter, the at least one controller configured to apply a first Direct Current (DC) bias to the first phase shifter, a second DC bias to the second phase shifter, and a third DC bias to the third phase shifter for controlling values of the first phase shifts, the second phase shifts, and the third phase shifts.

8. The quantum processing unit of claim 1, wherein each of the first phase shifter, the second phase shifter, and the third phase shifter is a multi-transverse-mode thermo-optic phase shifter.

9. The quantum processing unit of claim 1, wherein the first phase shifter, the second phase shifter, and the third phase shifter are configured for independently imparting the first phase shifts, the second phase shifts, and the third phase shifts to the optical modes to encode one or more qubits using single photons provided at the first and the second input waveguide arm of the first multimode interferometer.

10. The quantum processing unit of claim 1, wherein the third multimode phase shifter is optically coupled to the first output waveguide arm of the second multimode interferometer and is configured to impart the third respective phase shifts to optical modes of the third optical wave propagating in the first output waveguide arm of the second multimode interferometer.

11. The quantum processing unit of claim 10, further comprising a fourth multimode phase shifter optically coupled to the second output waveguide arm of the second multimode interferometer and configured to impart fourth respective phase shifts to optical modes of a fourth optical wave propagating in the second output waveguide arm of the second multimode interferometer.

12. The quantum processing unit of claim 1, wherein the third multimode phase shifter is optically coupled to the first input waveguide arm of the first multimode interferometer and is configured to impart the third respective phase shifts to optical modes of the third optical wave propagating in the first input waveguide arm of the first multimode interferometer, further comprising a fourth multimode phase shifter optically coupled to the second input waveguide arm of the first multimode interferometer and configured to impart fourth respective phase shifts to optical modes of a fourth optical wave propagating in the second input waveguide arm of the first multimode interferometer.

13. A quantum processing system comprising an interconnected plurality of the quantum processing unit of claim 1 arranged in one of a Reck mesh configuration, a Diamond mesh configuration, a Clements mesh configuration, and a Bokun mesh configuration.

14. A method for configuring the quantum processing unit of claim 1, comprising:
(a) applying a first Direct Current (DC) bias to the first phase shifter, a second DC bias to the second phase shifter, and at least a third DC bias to at least the third phase shifter to control the first phase shifts, the second phase shifts, and at least the third phase shifts;
(b) providing photons to the first and the second input waveguide arms of the first multimode interferometer;
(c) measuring the optical modes at an output of the quantum processing unit, the optical modes as measured indicative of actual values of the first phase shifts, the second phase shifts, and at least the third phase shifts;
(d) comparing, based on the optical modes as measured, the actual values of the first phase shifts, the second phase shifts, and at least the third phase shifts to target values; and
(e) when the actual values of the first phase shifts, the second phase shifts, and at least the third phase shifts deviate from the target values, adjusting at least one of the first DC bias, the second DC bias, and at least the third DC bias and repeating steps (b) to (e).

15. The method of claim 14, wherein the first DC bias, the second DC bias, and at least the third DC bias are applied to cause the quantum processing unit to be in one of an Hadamard gate configuration, a CNOT gate configuration, a CPhase gate configuration, and a Pauli gate configuration.

16. A method for providing a quantum processing unit, comprising:
providing a first multimode interferometer and a second multimode interferometer;
optically coupling an input of each of the first multimode interferometer and the second multimode interferometer to a first and a second input waveguide arm, and an output of each of the first multimode interferometer and the second multimode interferometer to a first and a second output waveguide arm;
interconnecting the first output waveguide arm of the first multimode interferometer and the first input waveguide arm of the second multimode interferometer via a first multimode phase shifter, the first multimode phase shifter configured to impart first respective phase shifts to optical modes of a first optical wave received at the first input waveguide arm of the first multimode interferometer and propagating in the first output waveguide arm of the first multimode interferometer;
interconnecting the second output waveguide arm of the first multimode interferometer and the second input waveguide arm of the second multimode interferometer via a second multimode phase shifter, the second multimode phase shifter configured to impart second respective phase shifts to optical modes of a second optical wave received at the second input waveguide arm of the first multimode interferometer and propagating in the second output waveguide arm of the first multimode interferometer; and
optically coupling one of the output of the second multimode interferometer and the input of the first multimode interferometer with at least a third multimode phase shifter, the third multimode phase shifter configured to impart third respective phase shifts to optical modes of a third optical wave propagating at the one of the output of the second multimode interferometer and the input of the first multimode interferometer.

17. The method of claim 16, wherein the third multimode phase shifter is optically coupled to the first output waveguide arm of the second multimode interferometer and is configured to impart the third respective phase shifts to optical modes of the third optical wave propagating in the first output waveguide arm of the second multimode interferometer.

18. The method of claim 17, further comprising optically coupling a fourth multimode phase shifter to the second output waveguide arm of the second multimode interferometer, the fourth multimode phase shifter configured to impart fourth respective phase shifts to optical modes of a fourth optical wave propagating in the second output waveguide arm of the second multimode interferometer.

19. The method of claim 16, wherein the third multimode phase shifter is optically coupled to the first input waveguide arm of the first multimode interferometer and is configured to impart the third respective phase shifts to optical modes of the third optical wave propagating in the first input waveguide arm of the first multimode interferometer, further comprising optically coupling a fourth multimode phase shifter to the second input waveguide arm of the first multimode interferometer, the fourth multimode phase shifter configured to impart fourth respective phase shifts to optical modes of a fourth optical wave propagating in the second input waveguide arm of the first multimode interferometer.

20. The method of claim 16, further comprising arranging a mode sensitive phase shifter and a mode insensitive phase shifter in a cascade configuration to form each of the first phase shifter, the second phase shifter, and the third phase shifter, the mode insensitive phase shifter configured to impart a same phase shift to the optical modes and the mode sensitive phase shifter configured to impart a different phase shift to the optical modes.
